(19) United States
(12) Patent Application Publication
(10) Pub. No.: US 2009/0000450 A1
(43) Pub. Date: Jan. 1, 2009

(54) CRANK ROLLER PAPER CUTTING DEVICE

(76) Inventor: Yeqing Deng, Dongguan City (CN)

Correspondence Address: MORRISS OBRYANT COMPAGNI, P.C., 734 EAST 200 SOUTH, SALT LAKE CITY, UT, 84102, US

(21) Appl. No.: 12/107,662

(22) Filed: Apr. 22, 2008

Related U.S. Application Data
(63) Continuation of application No. 11/336,445, filed on Jan. 20, 2006, now Pat. No. 7,360,482.

(30) Foreign Application Priority Data
Jan. 20, 2005 (CN) 200510032847.9

(51) Int. Cl. B26D 1/14

(52) U.S. Cl. 83/491

(57) ABSTRACT

This invention reveals a crank roller paper cutting device, which comprises a base, a supporter, a handle part, a master roller, a slave roller, and a group of speed-reducing gears. Via the group of speed-reducing gears, handle part correlates to the master roller and slave roller at one terminal, both of the master roller and slave roller are captured by the open bores therewith on the supporter. While the other ends of master roller and slave roller are suspended in the air, where a removable positioning block is attached. Upon the above said positioning block, there are two open bores or blink holes in correspondence to the master roller and slave roller respectively. Around the master roller and slave roller are many removable regulating cylinders or one regulating cylinder in different thickness. This crank roller paper cutting device is reasonable in design, easy to use and safe in operation for a wide range of applications, particularly valuable for kindergarten enlightenment education.

### FIELD OF THE INVENTION

This invention relates to an image cutting device, more particularly, a crank roller paper cutting device.

### DESCRIPTION OF THE PRIOR ARTS

Traditionally, paper-cut artwork is a popular, diverse and highly enjoyable art form for many persons, especially for children in early-stage studies. Outside China, there are many countries having employed this kind of art for child learning. For example, in Unite States, people usually apply paper sheet, plastic, rubber or similar materials to cut into letters, cartoons, animals or human beings to train perception and distinction of the babies. However, traditional handmade image products are lower in efficiency and poorer in coincidence without the capability for mass production. In order to overcome such deficiency, people invented a new method for large scale production by manufacturing an image cutter initially. They bent a thin and sharp blade into an image shape and then fix it onto a piece of wood. Later, they apply this cutter consequently to paper sheet or some other flat materials to produce identical images. If they'd like to generate another image product, just change to a different cutter, as P.R. China Utility PATENT NO. 01209608.3 disclosed. China Utility Patent No. 200420071603.2 disclosed another image cutter. Even though this type of image cutter can produce flat image manually, the operation is laborious and intensive, and easy to cause unevenness on press (that is, different parts on the flat material receive different pressures). In regard to mechanical operation associated with such image cutter, an US invention U.S. Pat. No. 6,619,195 reveals a type of paper cutting device, as FIG. 1 shows (from American Patent Publication), by attaching a pressing component to the image cutter in order to cut images via the force of leverage. Such device, however, inherits defects below: 1) not safe in operation. Internal structure of the device is exposed to air without any cover. People incline to hurt himself in case of putting finger or other part accidentally under the pressing block in time of pressing the leverage. 2) huge in size. Since the device needs a longer arm for the leverage, it is larger in size and inconvenient for package, storage or transportation. Another patent from China, No. 03317878.X, discloses a type of “roller paper cutting device”, as FIG. 2 shows, which comprises of a master roller connected to a handy wheel and a slave roller fixed on the base. Image cutter can be put into the space between the two rollers and cut the images subsequently. This roller paper cutting device is convenient in operation and smaller in size, but it possesses obvious deficiency too: space between these two rollers, the master and slave, is difficulty to change, so it is fit only for the image cutter with the same thickness, not for all image cutters. Therefore, applications of this device are limited. Besides, since it acquires driving force directly from the handy wheel on the master roller without the help of speed reducing gears, rotating force is necessarily high indeed, not suitable for children or other weak persons.

### SUMMARY OF THE INVENTION

It is, therefore, the objective of this invention to provide a reasonable, simple-structured, labor-saving and easy-to-use crank roller paper cutting device to overcome imperfectness of contemporary technologies, in conjunction with image cutters in a variety of thickness.

This objective is achieved by employing technique as follows: this crank roller paper cutting device comprises a base, a supporter, a handle part, a master roller and a slave roller, wherein it also includes a group of speed reducing gears. Via this group of speed-reducing gears, handle part correlates to the master roller and slave roller at one terminal. Both of the master roller and slave roller are captured by the open bores therewith on the supporter. While the other ends of master roller and slave roller are suspended in the air, where a removable positioning block is attached. Upon the above said positioning block, there are two open bores or blink holes in correspondence to the master roller and slave roller respectively. Around the master roller and slave roller are multiple layer removable regulating cylinders or one regulating cylinder in different thickness.

The said group of speed reducing gears consists of a gear A, which is relatively fixed in connection with handle parts, and a two-scale gear B, which is relatively sliding in connection with the master roller, a two-scale gear C, which is relatively fixed in connection with the master roller, a two-scale gear D, which is relatively sliding in connection with the slave roller, and gear E, which is relatively fixed in connection with the slave roller. The said gear A is snapped with the big scale one of the gear B, whose small one is, in turn, snapped with the big scale one of the gear D. While the small scale one of the said gear D is subsequently snapped with the big one of the gear C, whose small one, in succession, is snapped with gear E.

The said supporter consists of two parallel supporting plates. Upon the two parallel supporting plates, there are four open bores matched with each other in two pairs. The said master roller and slave roller pierce through the open bores on the two supporting plates and are kept parallel in level, perpendicularly to the supporting plates.

The portion of said master roller and slave roller that is hanged in the space between the two parallel supporting plate is held by positioning rings or protruding tables.

The said two parallel supporting plates have rotating bearings mounted inside the four bores.

The said handle pail is made up of a handy wheel or handy stick.

The said positioning block, which is in correspondence to the master roller and slave roller, has rotating bearings mounted inside the open bores or blind holes.

The said multiple layer regulation cylinders are made up of a series of same length but different diameter cylinders inserted one by another. Each cylinder is jointed with each other in sequence.

The side single cylinder in different thickness constitutes a series of regulation cylinders. Once applied with an image cutter with certain thickness, just select a cylinder in the same thickness and put on to the master roller or slave roller. In case of using another image cutter, merely change to another cylinder in different thickness.

The said regulation cylinder (the press cylinder which contacts the blade of image cutter) is made of non-rigid materials with certain hardness, such as plastic PP, PC, ABS, AS or nylon 66. Purpose of this is to avoid damage to the blade while pressing the image cutter properly.

The said base has suckers downside. The said suckers can keep this device stick to the operation table without much movement so as to insure device functions normally. The said sucker can be made of plastic (i.e. PVC) or rubber.

Principle of this invention is: wheeling the handle part by hand, the master roller and slave roller are rotated in reverse directions driven by the group of speed reducing gears. Place the image cutter inside the space between these two rollers and the image cutter shall be carried rolling over the rollers. Squeezed by the master roller as well as the slave roller, the image cutter scissors the inside flat material into a shape of the blade, such as, for example, a letter, carton, animal or human image.

Compared with contemporary technology, this invention is characterized with following advantages and effects: 1) easy in operation: this crank roller paper cutting device employs a group of gears as driving force with lager powers. Its impact is little, operation is stable, and laboriousness is less. Hence, it is convenient especially for children with weak strength. 2) safe in use: this device acts slowly without any large impact on people and can avoid accidental injury to users effectively. 3) wide in application: quantity and sizes of regulation cylinders can be changed simply in line with different image cutters. Many image cutters can be adapted by the same device. Thus, this device is more flexible in application. 4) reasonable in structure: this device is compact in structure and smaller in size. It is expedite for package, storage and transportation, and particularly valuable for families to enlighten their kids.

### BRIEF DESCRIPTION OF THE DRAWINGS

FIG. 1 is a sketch showing the structure of a type of contemporary leverage paper cutting device.

FIG. 2 is a sketch showing the structure of a type of contemporary roller paper cutting device.

FIG. 3 is a sketch showing the structure of this crank roller paper cutting device.

FIG. 4 is a sketch showing the structure of this crank roller paper cutting device after removing the supporter cover.

FIG. 5 is a stereograph of this crank roller paper cutting device.

FIG. 6 is a sketch showing the structure of the multiple layer regulation cylinders.

FIG. 7 is a sketch showing the structure of another regulation cylinder.

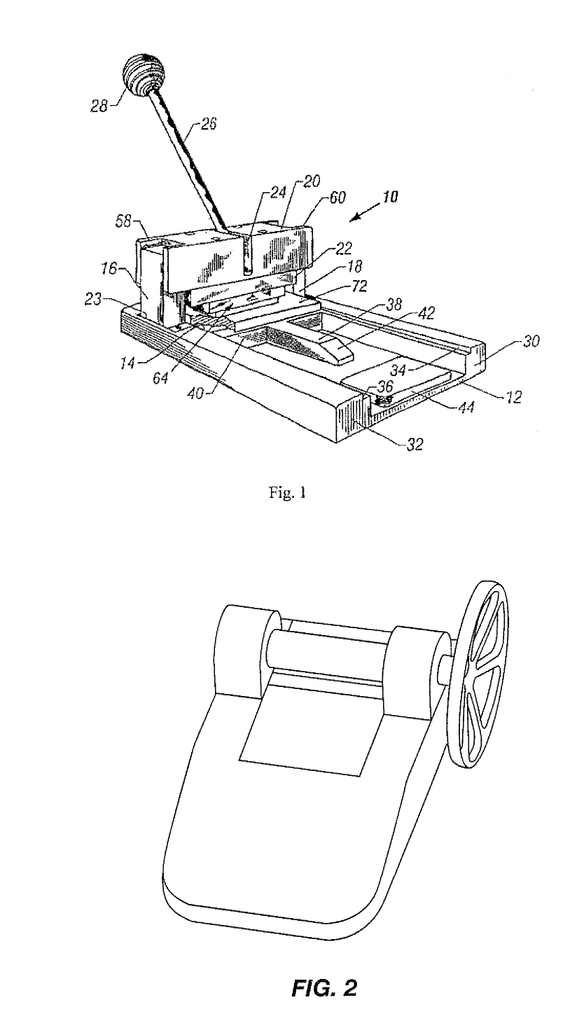

### DETAILED DESCRIPTION OF THE EMBODIMENT

Following is a detailed description about the invention based on example with drawings.

### Example 1

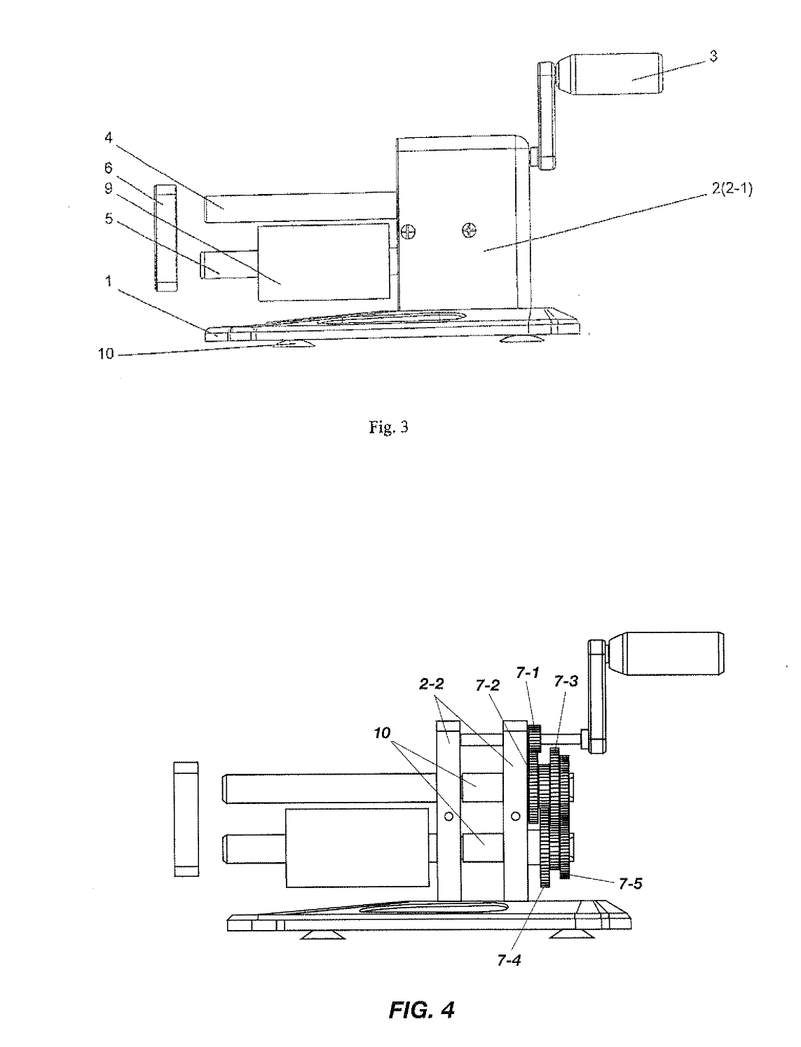

FIGS. 3˜4 illustrate the detailed structure of the invention. From FIG. 3, one can see this crank roller paper cutting device comprises a base 1, a supporter 2, a handle stick 3, a master roller 4, a slave roller 5, and a positioning block 6. From FIG. 4, one can see there is also a group of speed reducing gears 7. Via this group of speed-reducing gears 7, the said handle part 3 correlates to the master roller 4 and slave roller 5 at one terminal. Both of the master roller 4 and slave roller 5 are captured by the open bores therewith on the supporter 2. The other ends of master roller 4 and slave roller 5 are suspended in the air (without supporter), where a removable positioning block 6 is attached. Upon the said positioning block 6, there are two open bores in correspondence to the master roller 4 and slave roller 5 respectively. Inside the open bores are bearings 8, and around the master roller 4 or slave roller 5 or both are multiple layer removable regulating cylinders 9.

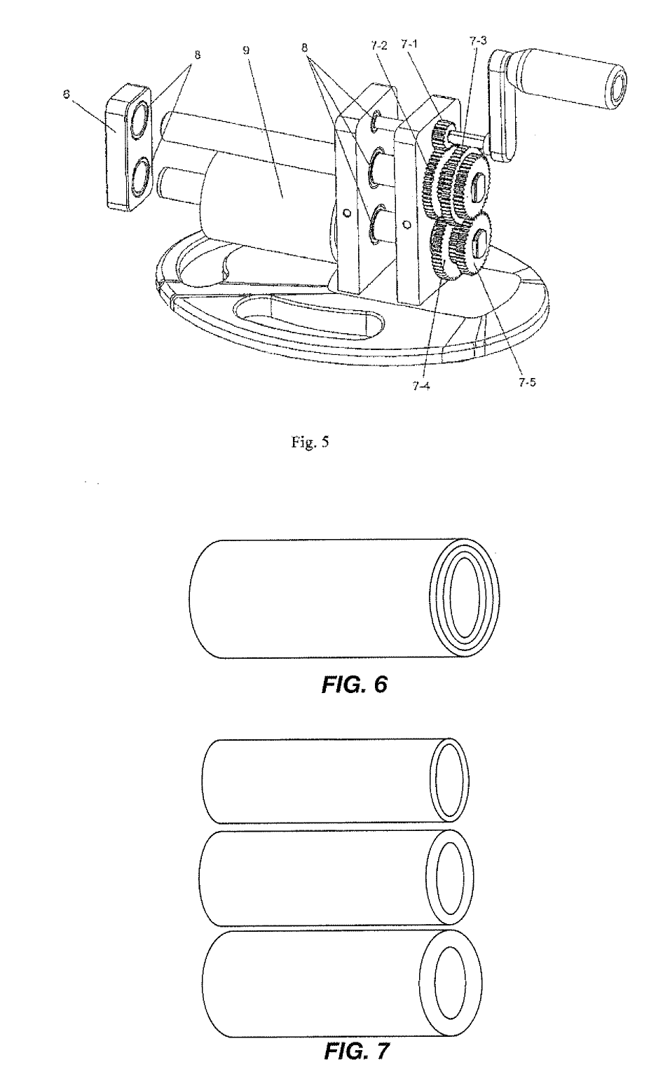

Detailed structure of the said speed reducing gear group 7 is illustrated by FIG. 4 and FIG. 5. It includes a gear 7-1, which is relatively in fixed connection to the handle stick 3, a two-scale gear 7-2 (the said two-scale gear is composed of two gears in different radius co-axial to the same shaft. Similarly below), which is relatively in sliding connection to the master roller 4, a two-scale gear 7-3, which is relatively in fixed connection to the master roller 4, a two scale gear 7-4, which is relatively in sliding connection to the slave roller 5, and a gear 7-5, which is relatively in fixed connection to the slave roller 5. Interactions among gears are: the said gear 7-1 is snapped with the large scale gear of the two-scale gear 7-2, the said two-scale gear 7-2 has its small scale gear snapped with the large scale gear of the two-scale gear 7-4, the said two-scale gear 7-4 has its small scale gear snapped with the large scale gear of two-scale 7-3, and the said two scale gear 7-3 finally has its small scale gear snapped with the gear 7-5. The said supporter 2 consists of a cover 2-1 and two parallel supporting plates 2-2.

Upon the two parallel supporting plates 2-2, there are four open bores matched with each other in two pairs. The said master roller 4 and slave roller 5 pierce through the four open bores on the supporting plates 2-2 and both, the master roller 4 and slave roller 5, are kept parallel in level, perpendicularly to the two supporting plates 2-2; the portion of said master roller 4 and slave roller 5, which is hanged in the space between the two parallel supporting plate 2-2, is held by a positioning ring 10; inside the four open bores on the two supporting plates 2-2 are rotating bearings 8.

The said multiple layer regulation cylinders 9 are consisted of three different diameter but same length cylinders inserted one by another. Each cylinder is jointed with each other in sequence. Detailed structure is showed in FIG. 6. The said regulation cylinder 9 (that is, the pressing cylinder which contacts with the blade of image cutter) is made of non-rigid materials with certain hardness, like PP; Purpose of choosing this type of material is to avoid damage to the blade of image cutter while keeping it work properly.

The said base 1 has suckers 10 downside as FIG. 3 shows; Role of the said suckers is to preserve this device stick to the operation table with no movement in order to insure it functions normally. The said sucker 10 can be made of plastic (i.e. PVC) or rubber.

Principle of the invention is: by wheeling handle stick 3 with hand, gear 7-1 rotates. The rotating gear 7-1 snap-drives the two-scale gear 7-2 consequently (but at that time, gear 7-2 dose not drive the master roller 4). The two-scale gear 7-2, in turn, drives the two-scale gear 7-4 (but at that time, gear 7-4 dose not drive the slave roller 5). The two-scale gear 7-4 later drives the two-scale gear 7-3, which, the two-scale gear 7-3, drives master roller 4 to rotate finally. In addition to this, two-scale gear 7-3 also drivers gear 7-5 in same time, who, the gear 7-5, subsequently drives the slave roller 5 to rotate in opposite direction to the master roller 4. From then on, place the image cutter into the space between master roller 4 and slave roller 5. The rotating master roller 4 and slave roller 5 shall carry the image cutter rolling over the space between the two rollers and the blade of the cutter squeezed by the master roller 4 and slave roller 5 shall scissor the inside flat material into a shape of the blade, such as a letter, cartoon, animal or human image.

### Example 2

This embodiment is identical to example 1, except that: around the master roller 4 or slave roll 5 or both, there is a single layer regulation cylinder 9 with different thickness; the said different thickness cylinder 9 forms a series of regulation cylinders, as FIG. 7 shows. Once applying a type of image cutter in certain thickness, just select a regulation cylinder 9 in the same thickness and put it on to the master roller 4 or slave roller 5; in case of using another image cutter, merely change to another regulation cylinder 9 with different thickness.

While the above description is conceived to be the most practical embodiments for this invention, it is recognized that this invention is not limited to the examples disclosed above. Any departures, such as alternation, modification or substitution, which are made therefrom within the scope of the invention, are regarded as equivalent replacement thereof and shall be embraced in the protection rang of this invention.

1. A crank roller paper cutting device, comprising a base, a supporter, a handle part, a master roller and a slave roller, wherein:
a group of speed reducing gears is supplied. Via this group of speed-reducing gears, handle part correlates to the master roller and slave roller at one terminal. Both of the master roller and slave roller are captured by the open bores therewith on the supporter. While the other ends of master roller and slave roller are suspended in the air, where a removable positioning block is attached. Upon the above said positioning block, there are two open bores or blink holes in correspondence to the master roller and slave roller respectively. Around the master roller and slave roller are multiple layer removable regulating cylinders or one regulating cylinder in different thickness.

2. A crank roller paper cutting device according to claim 1, wherein:
the said group of speed reducing gears consists of a gear A, which is relatively fixed in connection with handle parts, and a two-scale gear B, which is relatively sliding in connection with the master roller, a two-scale gear C, which is relatively fixed in connection with the master roller, a two-scale gear D, which is relatively sliding in connection with the slave roller, and gear E, which is relatively fixed in connection with the slave roller. The said gear A is snapped with the big scale one of the gear B, whose small one is, in turn, snapped with the big scale one of the gear D. While the small scale one of the said gear D is subsequently snapped with the big one of the gear C, whose small one, in succession, is snapped with gear E.

3. A crank roller paper cutting device according to claim 1, wherein:
the said supporter consists of two parallel supporting plates. Upon the two parallel supporting plates, there are four open bores matched with each other in two pairs. The said master roller and slave roller pierce through the open bores on the two supporting plates and are kept parallel in level, perpendicularly to the supporting plates.

4. A crank roller paper cutting device according to claim 3, wherein:
the portion of said master roller and slave roller that is hanged in the space between the two parallel supporting plate is held by positioning rings or protruding tables.

5. A crank roller paper cutting device according to claim 3, wherein:
the said two parallel supporting plates have rotating bearings mounted inside the four bores.

6. A crank roller paper cutting device according to claim 1, wherein:
the said handle part is made up of a handy wheel or handy stick.

7. A crank roller paper cutting device according to claim 1, wherein:
the said positioning block, which is in correspondence to the master roller and slave roller, has rotating bearings mounted inside the open bores or blind holes.

8. A crank roller paper cutting device according to claim 1, wherein:
the said multiple layer regulation cylinders are made up of a series of same length but different diameter cylinders inserted one by another. Each cylinder is jointed with each other in sequence; the side single cylinder in different thickness constitutes a series of regulation cylinders.

9. A crank roller paper cutting device according to claim 1, wherein:
the said regulation cylinder is made of non-rigid materials with certain hardness.

10. A crank roller paper cutting device according to claim 1, wherein: the said base has suckers downside.
